(19) United States
(12) Patent Application Publication
(10) Pub. No.: US 2002/0169801 A1
(43) Pub. Date: Nov. 14, 2002

(54) Web site converter

(76) Inventors: Martin Barnes, Ottawa (CA); David Pochopsky, Ottawa (CA); Craig Betts, Ottawa (CA); Youcef Bouayad, Ottawa (CA)

Correspondence Address: MARKS & CLERK, P.O. BOX 957, STATION B, OTTAWA, ON, K1P 5S7, CA

(21) Appl. No.: 09/784,187

(22) Filed: Feb. 16, 2001

(51) Int. Cl. G06F 17/30; G06F 17/00

(52) U.S. Cl. 707/513

(57) ABSTRACT

The Web Store Converter extracts information from an existing source, such as a web site, and translates that information into an immersive 3D environment characterized by a spatial visual representation of the data. The process is defined in two parts, the Web Store Crawler and the Web Store Builder. The Web Store Crawler is responsible for parsing data from the input source, refining the data, grouping it into departments, retrieving image files and generating the input for the Web Store Builder. The Web Store Builder is responsible for analyzing this data, designing the 3D rooms, connecting the rooms, filling the rooms with components and adding realistic styles to the 3D environment.

### BACKGROUND OF THE INVENTION

1. Field of the Invention

This invention relates to web site production, and in particular to a method of translating traditional web sites, product information and other types of data into immersive web environments with a spatial visualization of the data in three dimensions.

2. Description of the Prior Art

Typical websites, while graphic rich in content, are typically two-dimensional, that is they do not offer browsers an environment that simulates the real world. A customer interested in a particular class of products may follow the links associated with that class and end up at a page for purchasing a particular product, but this process does not resemble the real world of shopping.

Three dimensional websites that give the consumer the ability to navigate within a virtual environment exist, but they are extremely time consuming to set up. A typical e-commerce merchant selling goods through an flat established web site which has a transaction engine and fulfillment capabilities would need to completely set up the new website from scratch.

What is needed is a converter that will allow these merchants to offer a new way to navigate through their stores that is closer to the experience that customers have in real life.

### SUMMARY OF THE INVENTION

The invention permits the automatic creation of a website that simulates a real-world environment.

According to the present invention there is provided a method of transforming a flat web site comprising a plurality of pages containing items for display, each item being associated with hyperlinks pointing to a target destination, into an immersive web site having a three dimensional virtual environment, comprising crawling said flat website and parsing its content; identifying item links pointing to said items; for each item locating the associated hyperlink pointing to the target destination; associating said located item links with their corresponding hyperlinks to form link pairs; storing said link pairs in memory; processing said link pairs to remove redundant information and validate the associated data; grouping said remaining link pairs into subsets; for each subset creating a virtual room defined as a set of points in a three-dimensional virtual space; identifying display surfaces in said virtual room; and arranging said items on said display surfaces within said virtual space to display said items in a realistic setting while preserving said associated hyperlinks to the target destination.

Typically the link pairs relate to image files describing items, such as merchandise for display, but other types of files, such as audio, video can be used.

The items can, for example, be images of articles for sale, although it will of course be understood that they can represent intangible articles or services, such as vacation packages and the like.

An existing site may have links pointing to specific items for sale, for example, swimsuits. The link will take the potential customer to an image representing the swim suit. This image will be associated with another link taking the potential customer to another page giving more details of the item and providing a mechanism for placing an order. The invention places the first image in the three dimensional virtual space, but when the customer clicks on the image in the 3D space, he or she is taken back to the target destination to obtain more details about the item and/or place an order.

Generally, the images are placed directly in the virtual space, for example, in display cabinets, although it is possible to render the images themselves into 3D representations, although typically this will not be necessary.

Using this method, merchants can easily and seamlessly translate their existing web site into an “immersive” Web Store. The generated environment allows spatial representation of a store and its goods. The store managers do not have to maintain two different sites. They can keep maintaining their original web site and the converter can be automated to synchronize with the existing web site. They can also modify generated environments or build brand new ones.

Existing investment in site infrastructure and development for transaction management and web development are maintained. The Web Site Converter generates an environment that sits on top of the existing web site, leveraging the existing components.

Additional uses of the invention include the ability to translate other forms of data into “immersive” environments, such as stock market data, static text and information residing in database tables.

The invention allows the user to change settings regarding how the site is crawled, how the web store is to be built, etc. The user has a choice to run the process with minimal intervention or may choose to exercise control over virtually the entire process or specific parts of the process.

The information that is extracted from a target web site (or other source) and is converted into a list of image link pairs that will typically be represented as hyperlinked images in the resulting web store. The process may include other media types as well, e.g. audio, video, etc. Various refinements and filtering processes may be applied to the extracted data.

In a preferred embodiment, a grouping strategy may be applied to the data to automatically separate the image link pairs into departments that will be represented as separate rooms in the resulting web store.

To create input for the web store builder, a local directory and file structure is constructed, including generated data files. Any necessary files, such as the image files represented in the image link pairs, are retrieved to local storage.

The invention permits unique, realistic, immersive environments for each of the departments in the web store to be dynamically constructed. The product generates environments that do not have any obvious similarities and are of comparable quality to the traditionally modeled rooms. The web store builder is not in any way restricted to generating rooms strictly for online web stores. It can be used to enhance any hierarchal set of data which would benefit from a three dimensional representation.

The user can import new building blocks, room shapes and textures to be included in the web store builder. All subsequent web store constructions will have the newly imported items to choose amongst along with all previously imported components.

The user can easily customize and modify the web store. The options available include the creation/deletion of departments, create/delete/move hyperlinked images, and changing a room's shape. There are also a variety of layout techniques that the user may choose amongst to customize how images and building blocks are chosen and positioned.

All hyperlinked images are typically distributed throughout the rooms. The user can simply click on an image and the more detailed product information will be loaded from the original web site. In building the 3D site, it is desirable to reproduce the directory structure of the original site on a local computer, and also add an extra directory containing files storing information about the image pairs, for example, the link pairs associated with the items for display.

The invention also provides a web site converter for transforming a flat web site into an immersive web site having a three dimensional virtual environment, comprising a web site crawler including a parser for parsing said site and generating input data; and a web site builder for analyzing said input data, generating three dimensional rooms defined as a set of points in virtual space, and filling said virtual rooms with items identified by said web site crawler.

The web site converter will typically generate a VRML file, or other file serving as an input to a rendering engine that creates a representation of the 3D virtual space. A rendering engine is analogous to a web browser in that whereas a web browser takes HTML code and generates a web page for viewing, a rendering engine takes VRML code and generates a representation of the three-dimensional virtual space defined by the VRML code.

### BRIEF DESCRIPTION OF THE DRAWINGS

The invention will now be described in more detail, by way of example only, with reference to the accompanying drawings, in which:

FIG. 1 shows the main web crawler algorithm;

FIG. 2 shows the parser algorithm;

FIG. 3 shows an algorithm for refining the extracted data;

FIG. 4 shows the algorithm for grouping the data into department sized subsets;

FIG. 5 shows an algorithm for building departments;

FIG. 6 shows the main algorithm for building a webstore from the extracted data;

FIG. 7 shows a hierarchical representation of web store building blocks;

FIG. 8 shows a virtual room building algorithm;

FIG. 9 shows an algorithm for building the periphery of a virtual room;

FIG. 10 shows an activity diagram for a percentage layout scheme;

FIG. 11 shows an algorithm for creating a display case;

FIG. 12 is a diagram representing how interior components are laid out;

FIG. 13 is an algorithm for the installation of interior components;

FIG. 14 is an illustration of a pixel having the largest bounding box;

FIG. 15 is an illustration showing the addition of the first interior component;

FIG. 16 is an algorithm showing the creation and installation of tables;

FIG. 17 is an algorithm for installing tables along exterior walls;

FIG. 18 is an algorithm for adding tables around interior components;

FIG. 19 is an algorithm for adding tables anywhere; and

FIG. 20 illustrates the addition of tables in a floor plan.

### DETAILED DESCRIPTION OF THE PREFERRED EMBODIMENTS

Certain specific terms used herein are defined in the appended glossary.

As noted above, the invention permits a target flat website to be converted into a full immersive three-dimensional virtual environment. Typically, the target web site will be an e-commerce site, which in accordance with the principles of the invention can be converted into a true three dimensional virtual environment paralleling a real shopping experience, where the user can enter virtual rooms and view virtual items on display just as in a real store.

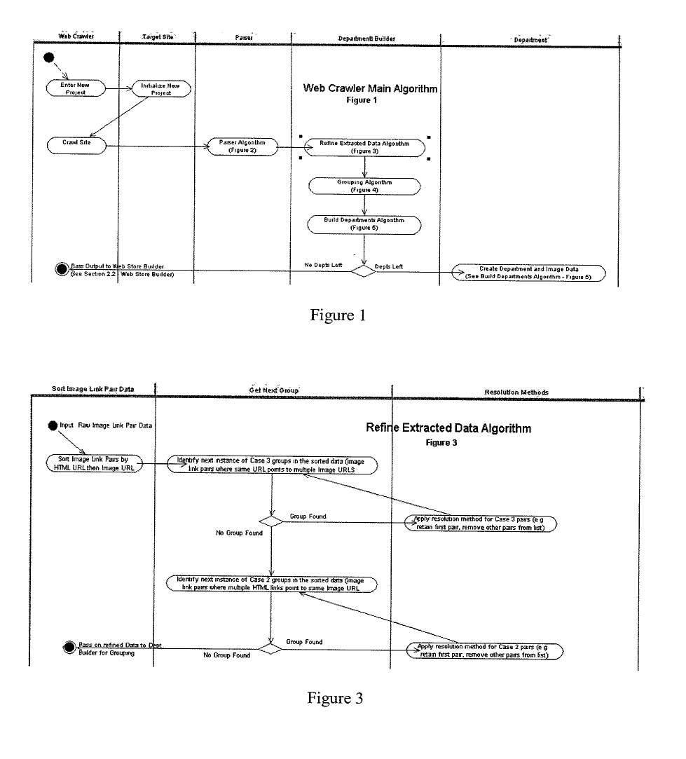

The first step is to gather information (and copy files) from a local or remotely stored web site (including distributed web sites) and output data to a local directory for further processing by the web crawler algorithm shown in FIG. 1.

First, the Web Store Converter application is started and the user starts a new project by entering the URL of a target site to analyze for the Web Store Builder. The new project is initialized; the user may edit project settings. The user then starts the crawl of the target site.

The Parser Algorithm begins to retrieve and extract image link pairs and other data from the target site. The list of extracted image link pairs is further refined to deal with possible redundant information in the extracted data. This is clarified in the Refine Extracted Data Algorithm.

The remaining image link pairs are then grouped into department-sized subsets. The grouping sizes are determined by user preferences or may be calculated automatically. The Grouping Algorithm elaborates on this process. After this, a loop is formed to build all the departments, including retrieving valid images and other context information.

The web store builder process is called with all necessary information passed or made available, i.e. the local directory where the output was generated and a list of department names.

The first step in the conversion process is to parse the target site one page at a time starting from a user-specified URL. The parser algorithm is shown in FIG. 2. Links are extracted from the first page and additional URLs of HTML pages are recursively retrieved and crawled until no new pages are discovered. Pages are parsed tag by tag and the contents of the tags are examined for patterns representing hyperlinks and image file locations.

The following description describes one way to parse through an HTML page, but it will be appreciated by one skilled in the art that many other ways can be employed consistent with the principles of this invention. This design is easily extensible to other documents, data storage devices and formats as well; for example, information stored in databases or XML documents could be crawled with only minor modifications. Similarly, although image files are currently retrieved, the process easily allows for other file types such as video, audio, etc. to be identified, retrieved and displayed in the web store.

A connection is attempted with a remote site using the specified URL. If the connection fails or is redirected the user is notified and prompted for action (connect error). If the connection succeeds the contents of the target page are read into memory. If the page cannot be read the user is notified and a new URL is requested. If the contents of the HTML page have been successfully retrieved then the first/next tag in the HTML text is retrieved. If there are no tags left in the document the next unparsed URL of the site is retrieved and parsed. If no more unparsed pages exist in the target site crawling is complete.

If a tag is retrieved it is examined to see if it contains an HTML URL (hyperlink) pattern. If it does not the next tag is retrieved. If a hyperlink pattern is detected the links contents are extracted and validated. If validation fails the next tag is retrieved. Link validation occurs as follows:

a. The prefix is examined to see if it is a relative link. If the link is relative an attempt is made to convert it to an absolute link.

b. If this link contains a string of characters indicating that it is outside the target site, has already been found, or is a script file, then it is said to contain a link excluder and is discarded.

If the link passes verification, belongs to the target site domain(s), and has not already been found it is added to the list of remaining links to crawl. It is temporarily stored while the next tag is extracted from the HTML text and examined. A new recursive loop is formed where succeeding tags are examined until one of these conditions is met:

a. An image link pattern is found.

b. An end anchor (end link) pattern is found.

If an image link is found, the link is extracted and validated as described above with the exception that image links are not discarded unless they fail a type check against desired image file extensions or fail to meet minimum width and height restrictions. Furthermore, upon passing validation the image link becomes associated with the hyperlink in temporary storage and forms an ‘image link pair’. If this image link pair is unique and in turn passes further checks, it is stored for further processing along with the URL of the originating page (and possibly other information) for use by the department builder later in the crawling process.

The Data structure for image link pairs is as follows:

Element1—{hypertext URL, image URL, context URL}

Element2—{hypertext URL, image URL, context URL}. . .

Element n—{hypertext URL, image URL, context URL}

The first two components form the image link pair while the third represents a context link, which is the URL of the page from which the image link pair was extracted.

If an end anchor tag is found, the image link fails any checks or the image link pair fails any checks, the process again searches for the next hyperlink.

When no tags remain in a document the next unchecked HTML page is taken from the list of remaining links to crawl. If a connection cannot be established with the next URL or there is an error reading the remote file the URL is discarded and the next link is processed. This continues until all pages in the list have been parsed.

The purpose of parsing the site is to extract as much useful information as possible from the target site for the generation of the web store. Filtering redundant information in the data is important because the image link pairs eventually become hyperlinked images in the web store being constructed. Ultimately, only the best images, associated with relevant html links are desired. Data that may be undesirable includes multiple copies of the same image or multiple images in the web store all linked to the same html page when clicked.

The cases below indicate specific examples of how such information may reside in the data, as well as how it is to be resolved. Three types of image link pairs are found in the data:

1. Unique html link unique—image link:

E.g. www.notvirtual.com/engine.html

www.notvirtual.com/images/engine.jpg

2. Several unique html links associated with the same image link:

E.g. www.notvirtual.com/news/index.html

www.notvirtual.com/banner.jpg . . .

www.notvirtual.com/careers/ottawa.html

www.notvirtual.com/banner.jpg

3. Several instances of the same html link point to multiple image links:

E.g. www.notvirtual.com/product/index.html

www.notvirtual.com/rack.gif . . .

www.notvirtual.com/product/index.html

www.notvirtual.com/fullview.jpg

Case 1 are desirable image links and usually require no refinement.

Resolution Methods for Cases 2/3:

Prior to crawling the site, the user has the opportunity to set preferences for how to deal with cases 2 and 3 above. Different methods can be applied to html links and image links; however, the order in which resolution methods are applied is significant. Five methods are presented, there are many others. Resolution may include one or a combination of the following:

a. Simple the first, last or another arbitrarily determined image link pair is saved and the others are discarded.

b. Save All—all image link pairs are saved resulting in redundant links and/or images in the resulting web store.

c. Best Image ambiguity may be resolved by pattern recognition algorithms designed to discover the image with the highest probability of being a person, object, scene, etc.

d. Image properties The pair containing the image with the largest dimensions, highest resolution or another image property may be selected.

e. Hypertext Properties The pair containing the hypertext link to the deepest page, a specified site name or another hypertext link property may be selected.

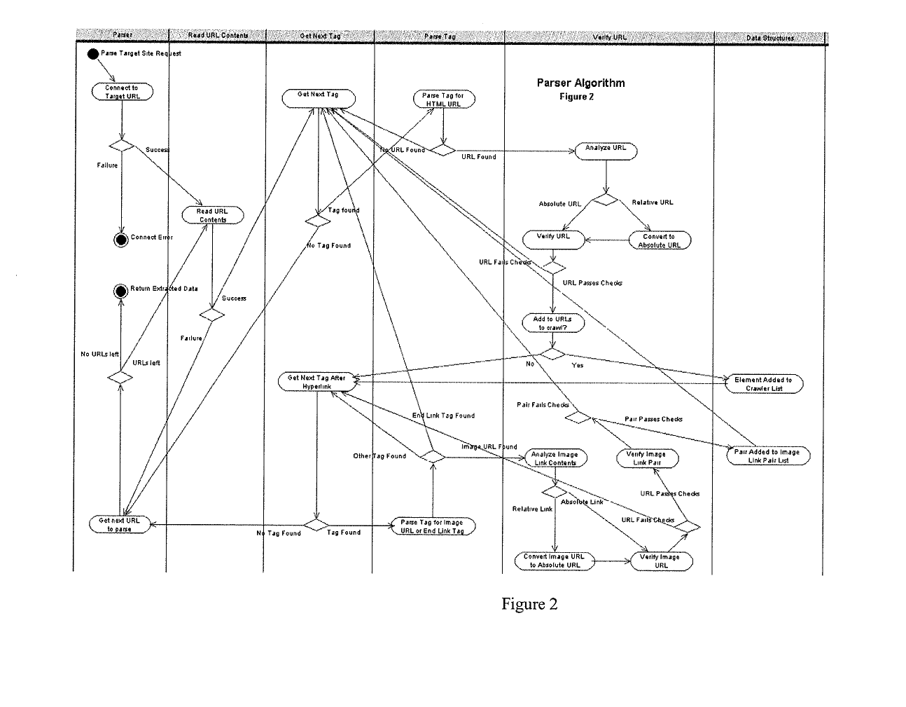

The algorithm shown in FIG. 3 is as follows:

1. The image link pairs are first sorted by the HTML URL then by the Image URL. This facilitates extracting groups of Case 2 and Case 3 instances.

2. Get the first/next groups of Case 3 instances (these will appear before instances of Case 2). If there are no Case 3 groups left go to step 4 below.

3. Apply the selected resolution methods for Case 3 groups. Return to step 2.

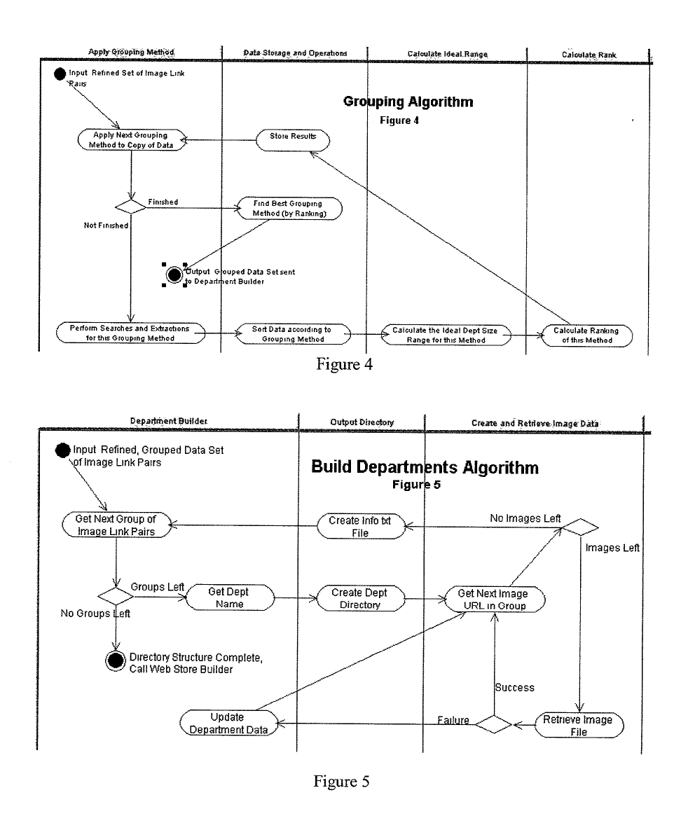

4. Get the first/next group of Case 2 instances. If there are no Case 2 groups left pass the refined data on to the Grouping Algorithm shown in FIG. 4.

5. Apply the selected resolution methods for Case 2 groups. Return to step 4.

Sorting image link pairs into department-sized groupings is accomplished by several methods. The department size or approximate number of images per room is a key factor and may be user defined, a default value or a calculated ideal range. For each method below a copy of the refined data set is used. Only three methods are described here; many other methods can be employed.

Context analysis Each image link pair is already associated with the URL of the page from which they were extracted. The first level of grouping is to sort the list of image link data by their originating page or context link. This method is useful for discovering end pages on a target site whose main entry link is a sectional page of related products containing thumbnail images linked to end product pages.

Steps:

1. The list of all image link pairs is sorted by context link.

2. This data is temporarily stored for further treatment.

Path analysis This grouping strategy attempts to partially recreate the file structure of the target site. Files are grouped according to the directories indicated in the URL's path. In example below, the ‘investors.html’ and ‘management.html’ files in the directory ‘section1’ would be grouped together:

http://www.notvirtual.com/section1/investors.html

http://www.notvirtual.com/section1/management.html

http://www.notvirtual.com/section2/engine.html

http://www.notvirtual.com/section2/subsectionA/browser. html

Path analysis may be applied to both hyperlinks and image file links. This method is advantageous for discovering traditional web site hierarchies for both departments and subdepartments that are organized by directory structure.

Steps:

1. The list of all image link pairs is duplicated and each is sorted. The first list is sorted by hyperlink directories, the second by image link directories.

a. The sort is implemented by parsing URLS by ‘/’s and recursively sorting the names of directories.

b. E.g. in the links above the directory name ‘sectionl’ is retrieved and will group two files together. Two additional groupings of one file are found in the example—‘section2’ and ‘subsectionA’, the latter possibly representing a subdepartment of ‘section2’.

2.The two sorted sets are stored temporarily for further treatment.

File analysis This level of grouping looks at the file names and arguments at the end of a URL and analyzes the syntax of these character strings for useful groupings. File analysis is best applied to hyperlinks rather than image file links. This method is useful for discovering data storage methods in effect at the target site, which are often ordered along product lines. A similar implementation of this method could extend the analysis to include the contents of certain html tags (e.g. title tags).

Steps:

1.The list of html links is used for the sort. The file name and any associated arguments (i.e. the character string from the last ‘/’ to the end of the URL) are extracted.

This string is added to the rest of the data associated with the image link pair.

2. A second pass is made over the data; the list of filenames is scanned for substrings that frequently appear. This occurs by a regular expression search for all character string combinations while maintaining a frequency count for repeating patterns discovered. These substrings are temporarily stored.

For example, these patterns typically occur in arguments that appear after filenames and represent the names of data structures in effect at a target site using dynamically served pages. For example, most pages in the Victoria's Secret site are similar to:

http://www2.victoriassecret.com/proddisplay/?prnbr=42-135292&cgname=OSBRPSTRZZZ

Thus, looking only in the filename substring of the URL:

?prnbr=42-135292&cgname=OSBRPSTRZZZ

The most frequently occurring patterns across the site will be ‘?prnbr=’, ‘&cgname=’ which seem to represent data structures used by their server.

3.On a third pass through the data, parsing the filename again, we use the substrings obtained to extract the contents of these arguments, in this case we have: ‘42-135292’ and ‘OSBRPSTRZZZ’ respectively.

4. Going back to the original data set we now sort the elements according to these substrings and temporarily store the result set.

Finding the Ideal Department Size:

It is desirable in some cases to automatically attempt to find the ideal department size for a web store. Two cases are when a user does not enter a range, or if the range they have entered lies far outside of groupings determined by the best grouping method (determined by rank, below). This calculated range is gauged by finding the mean and standard deviation of sorted data sets. Using the assumption that groupings with a lower variance represent the successful application of a grouping method we set the ideal range as the mean of this set ± one standard deviation.

Ranking Result Sets:

For each result set arrived at a rating is calculated. There are various ranking strategies, however, this implementation simply takes number of ideal sized groupings arrived at in the grouping method.

The highest rating associated with a result set determines which method is used. The generated result set is compared to the user's preferences (if any) to determine if the best fitted data set is significantly different from the user's desired outcome. If no user preferences have been entered all data from the best grouping method is used. The other sets are discarded and the final result set is built into departments.

Grouping Algorithm (FIG. 4):

1. The first/next grouping method is identified and applied to a copy of the data. If all appropriate grouping methods have been applied the best grouping method is determined by rank and the results are passed to the Department Builder Algorithm.

2. If there are grouping methods to apply, remaining, the next is chosen and any searches and extractions appropriate to this method are conducted.

3 Next the data is sorted as appropriate to the method.

4. The ideal department size range is calculated for this method.

5.The ranking of this method is determined.

6.The results are temporarily stored pending computation of remaining methods. Return to step 1.

On receiving the grouped image link pair data from the grouping algorithm, a loop is commenced to build the necessary output for each department. This is shown in FIG. 5.

1. The first/next group of image link pairs, representing a department, is retrieved. If there are no groups left the output is complete and the Web Store Builder is called.

2.If there are remaining department groupings, the Department name is automatically generated or specified by the user. The department directory is created locally.

3. The first/next image URL in the group is connected to and the file is attempted to be retrieved to the appropriate local department directory. If there are no image URLs left to process in this group the info.txt file (a data file) for this department is created and the next department group is fetched (step 1).

4. If during the image retrieval process something fails, the data for the department is updated to reflect the missing image file and step 3 is attempted with the next image URL.

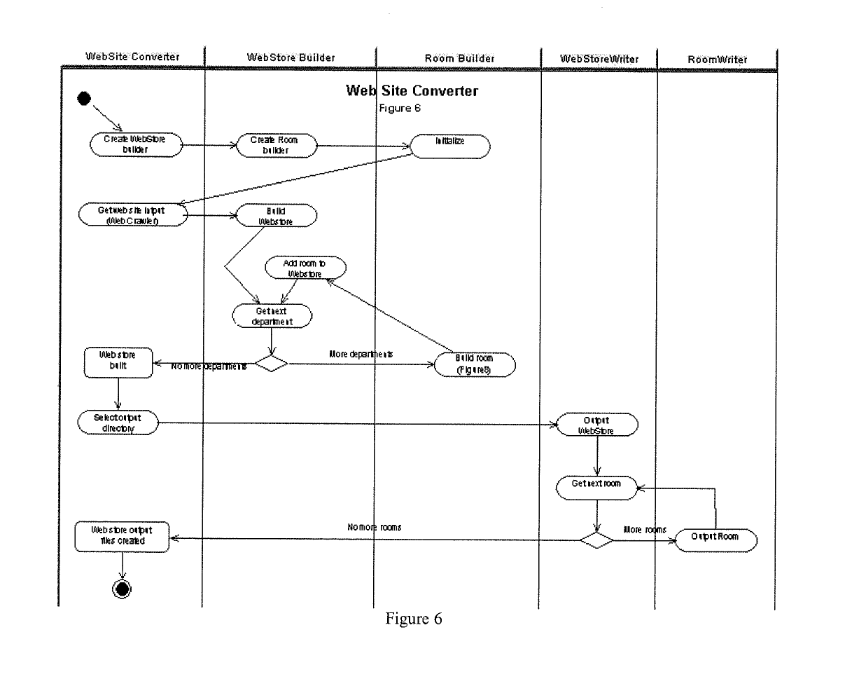

Next the output generated above is examined to create an immersive web store. This process is illustrated in FIG. 6.

The algorithm is as follows:

The WebStoreConverter creates an instance of the WebStoreBuilder and invokes the buildWebStore( ) method with a list of input directories for each of the web store's departments.

The WebStoreBuilder then creates an instance of RoomBuilder and issues the buildRoom( ) command for each room in the web store along with the room's input directory as a parameter.

The RoomBuilder parses the input files for a particular room, chooses the room's shape, installs all the room's building blocks and places the room's product images throughout the room

Once all rooms have been built, the WebStoreConverter creates an instance of WebStoreWriter and initiates the outputWebStore with the output directory as well as the output format for the three dimensional representation of the webstore.

The WebStoreWriter simply creates an instance of RoomWriter and for each room in the webstore, calls the outputRoom method.

The RoomWriter parses through all room building blocks, and based on the output format, generates the appropriate files to be used as input into a rendering engine.

The NVNWebStoreBuilder is the starting point in the construction of the three-dimensional web store. It is the controller class for the NVNWebStore and is responsible for providing the room builder with the necessary information to both construct the rooms, and insure the proper linking (via doors) between the rooms.

The NVNRoomBuilder is the controller class for the NVNRoom. It is responsible for the entire construction of the room, the placement of interior items as well as the placement of all images and doors throughout the room.

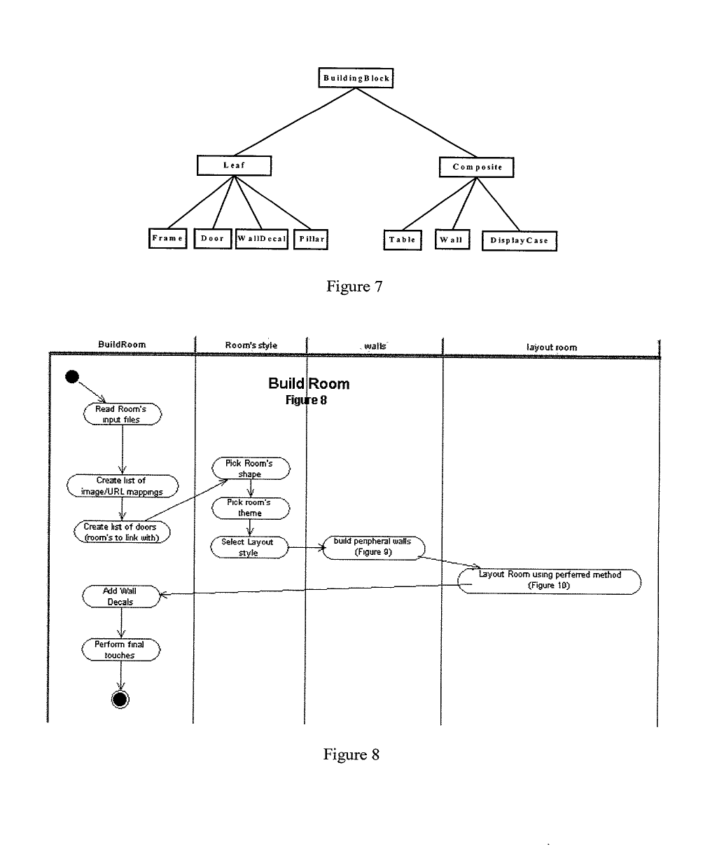

The room is made up entirely of building blocks. The building blocks are separated into two groups, those that can contain child building blocks and those, which cannot. FIG. 7 illustrates the classification and available building block types. All preconstructed building blocks have been normalized; therefore, the bounding cube for each component is originally no larger than (1 m×1 m×1 m). This simplifies the positioning and scaling of objects when installed in the room. Building blocks, which can hold picture frames, have what is referred to as display surfaces. The display surface is the portion of the building block that is capable of holding either a standup picture frame or a hanging picture frame. Building blocks, which have display surfaces, are walls, display cases, and tables, all of which are composite. When an image is assigned to a composite building block, it is really the picture frame, which is assigned to it, and the image is part of the picture frame. Images cannot be directly assigned to a composite building block.

When the room builder instance is created it's initialization involves two stages. The shape of each room is represented by a polygon; all available room shapes (polygons) are read in. All building blocks are read in along with the various texture groupings, which may be rendered on to the component. The building blocks consist of walls, display cases, tables, pillars, wall decals, doors and picture frames.

The steps for the construction of a room will now be described with reference to FIG. 8.

Every room will have an input file generated from the web crawler. The input file contains information such as; image/URL mappings, room name, and preferred layout scheme.

Once the room builder has completed its construction of the room, information will be appended to this file allowing a user to rebuild the room at a later time with the same style and layout as was originally created. If this data is found within the file, then it will be read in as well.

If the room's style was not specified within the room's input file, the room builder chooses it randomly to make each room unique.

The first stage is to pick the room shape amongst all room shapes, which have been installed into the room builder.

The second stage chooses the overall look and feel of the room; otherwise referred to as the style. Every building block available has several groupings of textures, which can be applied onto them. Each grouping has a style associated with it. When a component is selected for installation in a room, the room builder matches the room's style with the component's list of textures and randomly selects among the available textures for that style. For example, if the room's style is “gothic”, then perhaps many of the textures will resemble stone.

Other room specific details are decided; such as, the room's height, spacing between interior objects (walkway size), range of sizes for images etc.

The types of doors to be used are also chosen. One type, which is typically larger, connects the room to the parent room, and the second type joins this room to all child rooms (or sub departments). Once again the appropriate texture is selected based on the room's style.

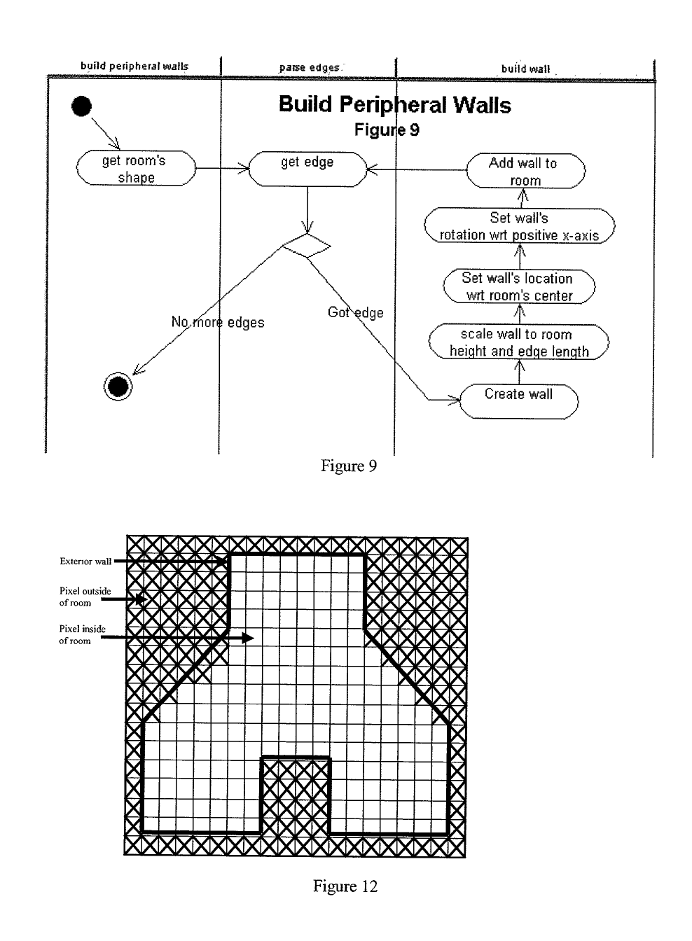

The peripheral walls are built by iterating through the edges of the polygon representing the room's shape. FIG. 9 illustrates the activity diagram for the process. The component selected during this stage is a simple plain wall with nothing on them. The wall will eventually have sub components installed on them such as wall decals, display cases and framed images; but this will occur during the layout stage.

The algorithm is as follows:

For each edge in polygon (in clockwise order) {

P1 = start point of edge
P2 = end point of edge
Wall width = length of edge
Wall height = room height
Wall location = center of edge [p1 + (p2 − p1) /

2]

Wall rotation = angle between edge (p1,p2) and the

positive x axis
} // end for each edge in polygon

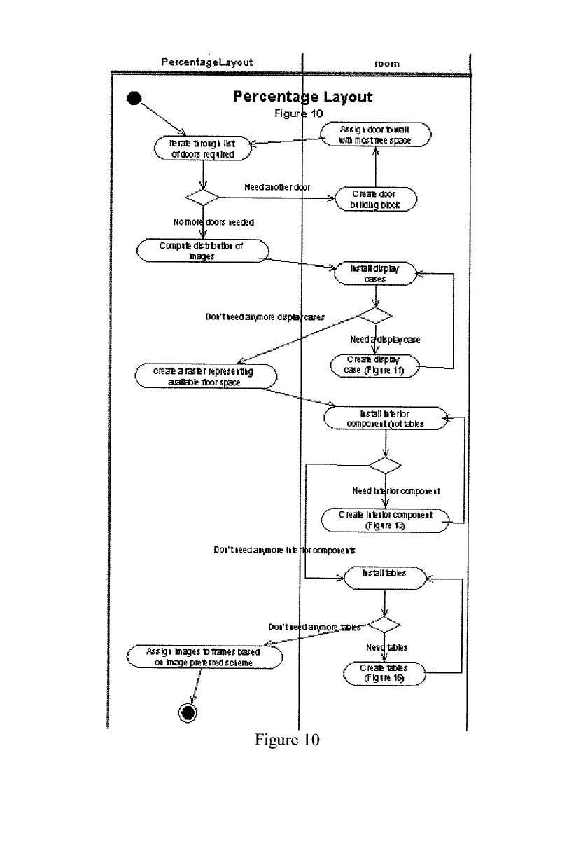

The room builder will have several layout methods to choose amongst. Each layout method is the workhorse of the algorithm. This document will cover only one of the layout schemes referred to as the Percentage Layout, which is illustrated in FIG. 10. The percentage method requires three percentages as input. The percentage of images to be placed on interior side of the peripheral walls, on top of tables and in/on interior components.

The user may select other layout schemes. The schemes available are as follows:

Percentage Layout

Maximize usage of peripheral walls

Maximize usage of floor space

At this time, the room's peripheral building block list consists only of exterior walls, which are sorted by the space availability of the walls in descending order. Next, doors are continually added to the walls, which have the most space remaining. Should there be insufficient space, the entire room is scaled. The algorithm is as follows:

NumDoorsRemaining = vecDoors.size( )
While (NumDoorsRemaining > 0) {

Wall = getWallWithMostSpace( )
Door = choose door type (based on whether parent

or child door)

Scale door based on room style (room height)
If (Wall.spaceLeft( ) < door width)

// Find wall with min scale factor to fit the

door

ScaleFactor =

getMinScaleFactorToFitComponent (door)

ScaleRoom(scaleFactor)
Wall = getWallWithMostSpace( )

Assign door to wall's display surface
NumDoorsRemaining = NumDoorsRemaining − 1

} // end While (NumDoorsRemaining > 0)

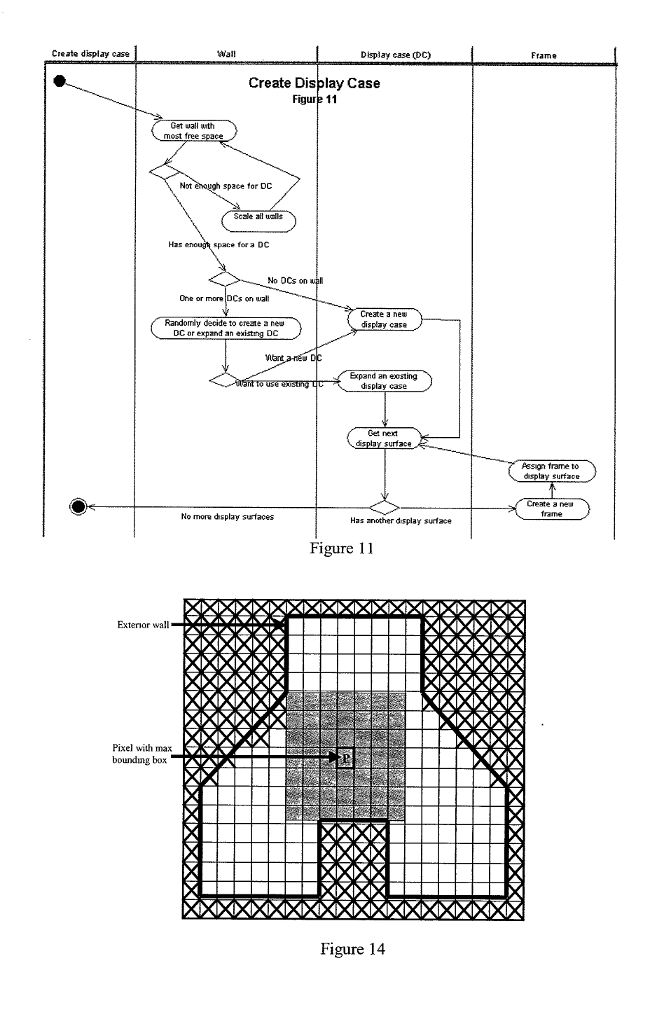

Display cases (DC) are used to hold picture frames to be placed on peripheral walls. The display cases (and textures) are chosen randomly amongst the installed cases supporting the room style. The display cases may have multiple display surfaces to hold images (i.e. shelves). Every attempt is made to eliminate empty display surfaces. Once the DC is assigned to the wall with the most free space, frames are assigned to the display surfaces. All display cases can be expanded to hold more picture frames; therefore, occasionally display cases will be scaled rather than building new ones. FIG. 11 illustrates the process for building or expanding a single display case.

The algorithm is as follows:

NumImagesRemainingForExtWalls =
PrecentImagesForExtWalls * numImages
While(NumImagesRemainingForExtWalls > 0) {

Wall = getWallWithMostSpace( )
If (SpaceLeftOnWall < min.DC size) {

ScaleFactor =

getMinScaleFactorToFitObjectOnAWall(

min.DC

size)

scaleRoom(scaleFactor)
Wall = getWallWithMostSpace( )

}

Randomly decide whether to add a new display case (DC) or expand an existing DC (if any) on wall.

If (expand an existing DC)

DC = pick a display case on wall to scale
/* Display case's widths are expanded by
their original width which is equal to min.
DC size
*/
Expand DC by the minimum DC size

Else (choose another DC) {

Randomly choose a display case such that
numberOfDisplaySurfaces <
NumImagesForExtWallsRemaining (so that no
display surfaces are left empty)
Scale DC by min. DC size (Scale width &
height by room height)

}
NumDisplaySurfaces = DC.getNumDisplaySurfaces( )
For each DisplaySurface (DS) {

NewFrame = randomly select frame amongst

available frames

Scale frame to minimum(maxFrameSize,

MaxSpaceAvailable)

Assign newFrame to DS
NumImagesRemainingForExtWalls - -

} // end for each display surface

} // end while NumImagesRemainingForExtWalls > 0)

The next stage is to build a grid representing floor space. This is carried out as follows:

1. Create a polygon (P_{FS}) representing the floor space in the room. The polygon is the same as the polygon for the room shape except that it is reduced in size by a one-meter perimeter to leave space for any display cases, which are protruding from the walls.

2. Create a raster with the same dimensions as the room shape's outer bounding box. The raster is used to represent the available floor space in a grid of 1 m by 1 m pixels. All pixels are initialized to null. Note that since the grid is based on the room shape it will always have a boundary (at least one pixel) surrounding the floor space polygon (P_{FS})

3. Using scan lines set all pixels to null which lie outside the P_{FS}. Once scan line enters inside the P_{FS}, set the pixel's bounding box size to 1×1. Doing so allows the algorithm to identify free floor space by any valid bounding box as shown in FIG. 12. The algorithm is as follows:

For each row in grid {

For each column in grid {

bBox = 1×1 bounding box centered at pixel

center

if(bBox liesCompletelyInside(Pfs)) // inside

the room

pixel = bBox

else

pixel = null

} // end for each col

} // end for each row

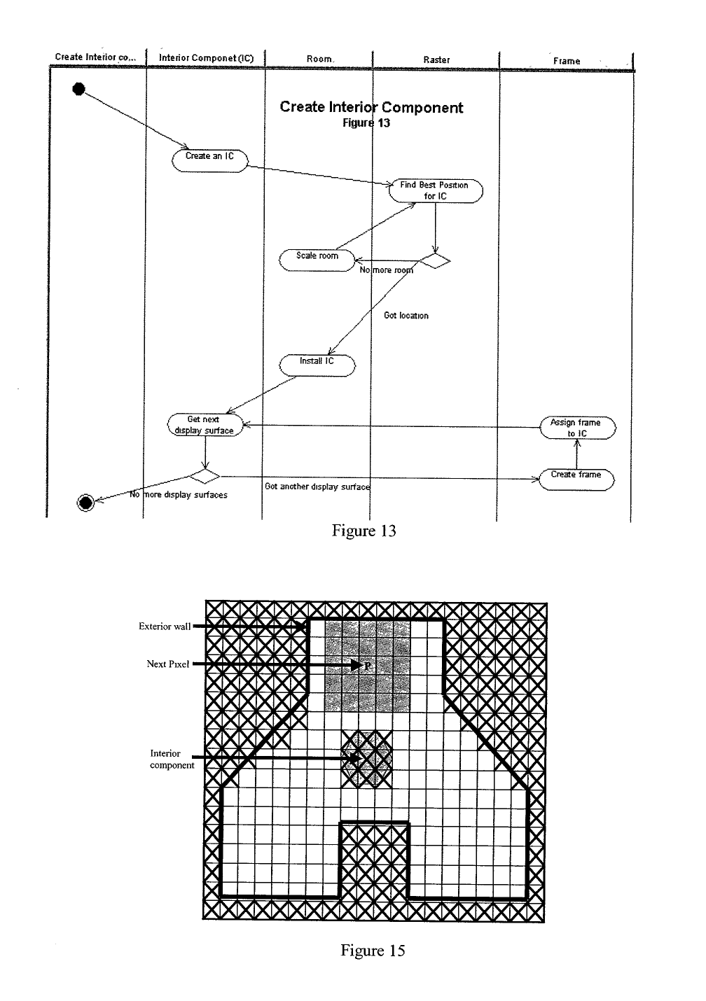

FIG. 13 shows how a single interior component is positioned into the room.

The algorithm for the installation of interior components consists of the following steps:

1. Iterate through the grid, all pixels, which are not null, represent available floor space. Compute the maximum square bounding box which can be centered at the current pixel. For the installation of interior components, the minimum size of the bounding box is 9 m by 9 m. This permits a 3 m walk space around the object, which has a minimum size of 3 m by 3 m. (See FIG. 14)

The algorithm is as follows:

For each row in grid {

For each column in grid {

If( pixel = = null)

continue

bBox = min bounding box (9×9) centered at

current pixel

/* Continuously try to scale the bBox evenly

in all directions so

the center remains at the current pixel

*/
while (bBox liesCompletelyInside(Pfs)) {

pixel = bBox
bBox = bBox increased by (2×2) (ie.

(9×9) -> (11×11) )

} // end while

} // end for each col

} // end for each row

2. Position an internal component within the largest bounding box in the grid. Once the object is installed update the grid by setting occupied pixels to null and updating all bounding boxes which were impacted by the installation. The algorithm is as follows:

NumImagesRemainingForIntComp = PercentImagesForIntComp
* numImages
While (numImagesRemainingForIntComp > 0) {

Pixel = get pixel with largest bounding box
If(pixel = = null)

// No more space left
scaleFactor = scaleFactorNeededForComponent

(minBBox)

scaleRoom(scaleFactor)
Rebuild the grid
continue

IntComp = randomly choose interior component
Scale intComp to 3×3
location = center of pixel
intComp.setLocation(location)
room.add(intComp)
setOccupiedPixelsToNull(intComp)
For each DisplaySurface (DS) {

NewFrame = randomly select frame amongst

available frames

Scale frame to minimum(maxFrameSize,

MaxSpaceAvailable)

Assign newFrame to DS
NumImagesRemainingForIntComp - -

} // end for each display surface
/* Must now update all pixels′ bounding box in the

grid because

many of them will have been reduced due to the
previous installation. This is similar to step 2
*/
For each pixel in grid {

BBox = pixel.getBBox( )
If(pixel = = null)

continue

if(BBox

liesOutside(listOfInteriorComponents))

continue

while(!bBox.liesOutside(listOfInteriorComponents))

bBox = bBox decreased (2×2)
pixel = bBox

} // end for each pixel in grid

} // end of while (numImagesRemainingForIntComp > 0)

The method of installing the tables is similar to that of the interior components. A minimum bounding box of size (8×7) is created, this permits a walkway space of 3 m surrounding the table, thus the minimum size of a table is (2×1). Tables are scaled in only one direction (width), maintaining a consistent depth of 1 m. The frames, which are placed onto the tables, have a maximum width of 1 m and have at least 0.5 m spacing between images and the edges of the table. Tables hold (width/2) picture frames.

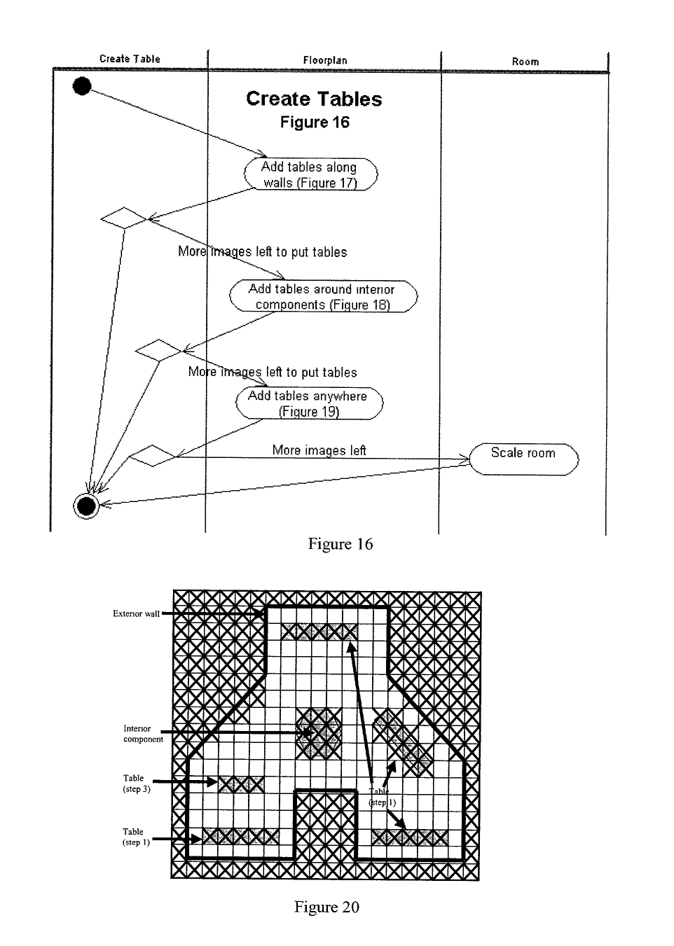

The process of adding tables will have at most 3 steps as outlined below. Exiting a stage will only occur if there is insufficient space to continue or the number of images remaining is zero. FIG. 16 shows the activity diagram for the process.

The algorithm is as follows:

While (numRemainingImagesForTables > 0) {

(1) InstallTablesAgainstWalls( )
If (numRemainingImagesForTables = = 0)

Break

(2) InstallTablesAgainstInteriorComponents( )
If (numRemainingImagesForTables = = 0)

Break

(3) InstallTablesAnywhere( )
If (numRemainingImagesForTables = = 0)

Break

// No more space in room for tables
scaleRoom

} // end while (numRemainingImagesForTables > 0)

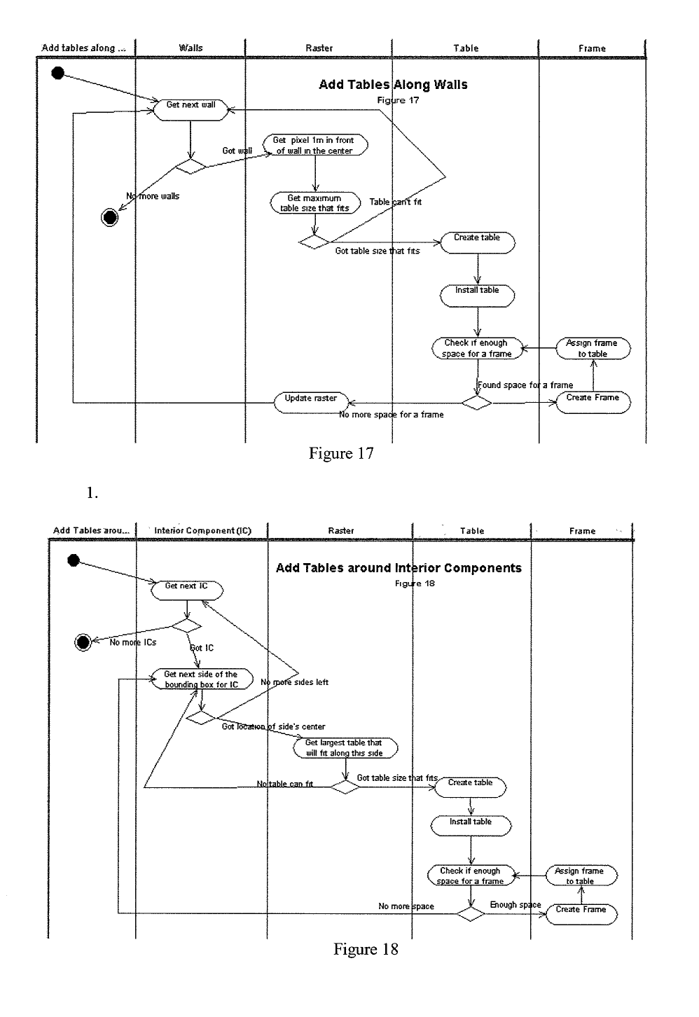

1.Installing tables against the exterior walls (See FIG. 17).

The algorithm is as follows:

For each exterior wall {

bBox = minBBoxForTable( )
bBox.translate(center of the wall's width and 1m

inwards, from wall )

bBox.rotate(same rotation value as the wall)
NumFramesOnTable = 0
While( (bBox lies inside Polygon for floor space

(P_{FS}) &&

(bBox lies outside all interior components)

&&

(bBoxWidth - 6(space for walkway) < wallWidth

))

maxTableBBox = bBox
numFramesOnTable ++
if (numImagesRemainingForTables < =

numFramesOnTable)

break

bBox = bBox width increased by 2

if (numFramesOnTable = = 0 )

continue

table = randomly choose a table
scale table to bounding box size - (6×6) // space

reserved for walkway

update the grid pixels which contain the table
for i=0; i<numFramesOnTable; i++)

Frame = create a new frame
Assign frame to the table
NumImagesRemaining - -

}
if (NumImagesRemaining = = 0)

return

} // end for each exterior wall

2. Installing tables around interior components' bounding box. (See FIG. 18)

The algorithm is as follows:

For each interior component

For each side of the component bounding box

(4sides)

bBox = minBBoxForTable( )
bBox.translate(center of object's bBox side

and 1m away)

bBox.rotate(same rotation value as the

object's bBox side)

While( (bBox lies inside Polygon for floor

space (P_{FS}) &&

(bBox lies outside all interior

components and tables))

maxTableBBox = bBox
numFramesOnTable ++
if(numImagesRemainingForTables<

=numFramesOnTable)

break

bBox = bBox width increased by 2
if (numFramesOnTable = = 0 )

continue

table = randomly choose a table
scale table to bounding box size - (6×6)
update the grid pixels which contain the

table

for (i=0; i<numFramesOnTable; i++)

Frame = create a new frame
Assign frame to the table
NumImagesRemaining - -

}
if (NumImagesRemaining = = 0)

return

} // end for each side

} // end for each interior component

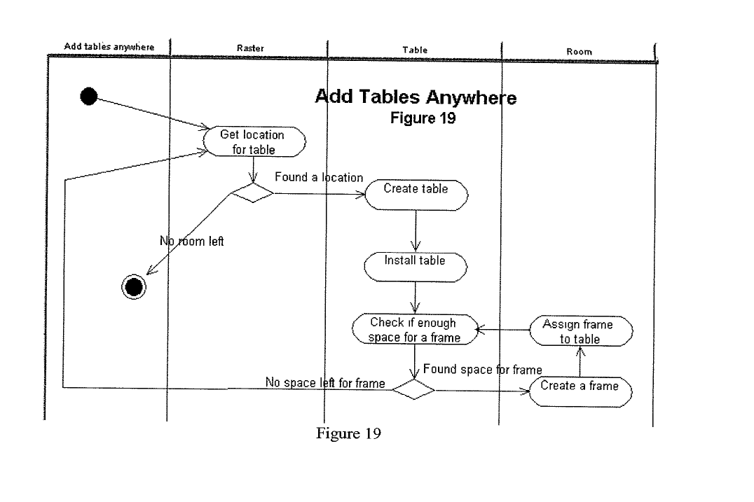

3. Installing tables anywhere is similar to the method of installing interior components. Using the grid method, center tables at the pixel whose bounding box is the largest (Refer to FIG. 19).

While (numFramesRemainingForTables > 0) {

Pixel = get pixel with largest bounding box
If (pixel = = null)

// No more space left
return

location = computeLocation (pixel)

table.setLocation (location)
room.add (table)
setOccupiedPixelsToNull (table)
/* Must now update the pixel's bounding boxes in

the grid because

many of them will have been reduced due to the
previous installation.
*/
For each pixel in grid

BBox = pixel.getBBox( )
If (pixel = = null)

continue

if (BBox liesOutside (listOfInteriorComponents

and tables))

continue

while (!bBox.liesOutside (listOfInteriorComponents

and tables))

pixel = bBox
bBox = bBox width decreased 2

} // end of while (numFramesRemainingForTables > 0)

Next images are assigned to the frames. The reason this is done after all room components have been created is to permit the control of the location of specific images. Several methods of placing the images are available; however, the default is as follows:

ImageIndex = 0;
For each exterior wall

For each display case

For each frame

Frame.addImage (imageList [imageIndex])
Image Index++

}
For each interiorComponent

For each frame

Frame.addImage (imageList [imageIndex])
Image Index++

}
For each table

For each frame

Frame.addImage(imageList [imageIndex])
ImageIndex++

Wall decals add a great deal of realism and uniqueness to the rooms. They consist of running boards, pillars, windows or any other possible enhancement to a wall. The running boards may or may not have both a top and bottom piece; nonetheless, they are scaled to fit the entire exterior wall and the texture is tiled on top of it. The running boards are located in their own reserved space, and no other objects invade this space unless they are part of the same style.

The pillars are positioned in the center of various wall sections, which are unoccupied. The chosen pillars are part of the same style as the running boards, and are designed to be placed together.

In order to ensure the room does not have large empty spaces the room builder has a variety of objects which act as fillers for the room. The filler objects include pillars, couches, desks and chairs; they are positioned throughout the room when sufficient space exists. The algorithm for this process is exactly the same as installing interior components described above.

As mentioned earlier, all interior components have a minimum bounding box of 3 m by 3 m and up until now they have all remained the same size. The room builder randomly chooses some of the interior components to scale (should there be sufficient space). The purpose of scaling the interior components is simply to make the interior components appear more unique, as well as reduce unused floor space.

The final steps are performed by the web store and room writers. The web store writer creates the root output directory for the web store, and

For each room in the web store {

Create room's output directory
RoomWriter.outputRoom (room)

} // end for each room

The room writer class basically performs the outputComponent method for every component in the room. It functions as follows:

For each component {

Perform all necessary translations and rotations on
component
Copy all necessary textures to room's output
directory
Append all object information (in appropriate 3d
format) to room's output file.
For each subcomponent {

OutputComponent (subcomponent)

} // end for each subcomponent

} // end for each component

It will thus be appreciated that the invention permits a flat web site to be automatically converted into an immersive virtual environment reminiscent of a real shopping experience.

Glossary

Absolute and Relative links—Absolute links are complete URLs in the sense that they contain all information regarding the remote source needed to find that source on the Internet or World Wide Web. For example, http://www.notvirtual.com/index.html specifies exactly the protocol to use ‘http://’, the name of remote machine—‘www.notvirtual.com’ and location of the file on that machine ‘/index.html’. Relative links are abbreviated versions of absolute URLs that can only be interpreted correctly if the context of the link is known. For example, if we are browsing the www.notvirtual.com website and follow the relative link ‘/product.html’ our browser may correctly assume that this html page resides in the root web directory of the www.notvirtual.com machine even though it was not explicitly stated in the hyperlink.

Bounding box—The smallest rectangle that can completely contain a particular polygon.

Building block—Every room is constructed completely from small components referred to as building blocks. Building blocks consist of walls, tables, display cabinets, interior components, wall decals and pillars.

Context link—the URL of an HTML page that contains valid image link pairs. Context links are stored with each image link pair extracted from the page and are used in determining department groupings.

Department—All web store images extracted by the Web Store Crawler are placed into groups that represent a specific department in the web store. Departments are represented as rooms in the generated web store.

Display surface—The portion of a building block that can have picture frames placed upon it; for example, a table typically has a single display surface, the table top.

End anchor—This refers to the closing tag of an HTML hyperlink, specifically ‘</a>’ or ‘</A>’.

End page—A web page in an e-commerce site representing a particular product. It is characterized by a lack of links going ‘deeper’ into a product area; it typically contains purchasing methods and detailed information regarding the product. End pages are the preferred building blocks of dynamically created web stores.

HTML Page—An HTML Page belongs to the Target Site. Through a manual navigation inside the web site a user can access to an HTML Page of the site. Some HTML pages contain links to other HTML pages and it is the job of the Web Crawler to identify as many HTML pages as possible.

File name (of a URL)—The file name of a URL is the character string from the last ‘/’ to the end of the string and typically consists of or contains the name of a file on the remote host. It may also contain arguments used by dynamic processes in effect on the target machine. These arguments are typically preceded by a ‘?’. For example, in the following URLs:

http://www.notvirtual.com/news/newsletter.html

http://www2.victoriassecret.com/index.cfm?prnbr=42-136500&cgname=OSDRGLACZZZ

The respective file names are:

newsletter.html

index.cfm?prnbr=42-136500&cgname=OSDRGLACZZZ

Image—In the context of the application, an Image represents an image from a target site, ideally that a potential customer can buy in the Web Store. The class that represents that concept contains the contents and context information relating to an image file retrieved from the target site. Each Image has a URL that identifies the location of the file on the Internet and a URL that identifies the original web page where the item can be purchased. It also contains methods for retrieving and filtering this information.

Image link pair—a pair of links extracted from a crawled site that represent a linked image in an HTML page or an image with a close association to an HTML page.

Interior component—Any object that has display surface(s) available for images to be placed upon, and that lie within the room away from the walls.

Link excluder—any string of characters that may appear within a hypertext link indicating that it is not a link of interest. Examples include ‘javascript:’ and ‘\cgi-bin’.

Lobby—The lobby is the main room of the Store. It mainly serves as a way to navigate through the entire store and to access the different departments of the store.

Peripheral wall—The outermost walls that define the room's shape.

Pillar—An object that is placed within the room or against a wall. It resembles a load bearing structure and its sole purpose is to add realism to the rooms.

Points to—A hyperlink or URL points to an HTML page means that when a user clicks on the hyperlink or URL, the browser will attempt to display the HTML page.

Relative Links—See Absolute and Relative links.

Room—A room is a three dimensional environment that contains all departmental information like images of the items that a customer can purchase and layout information used to build the corresponding VRML file.

Running Board—A portion of the wall decal that adds detail to the walls. The running boards are normally positioned either at the top or the bottom of the wall and protrude slightly away from it.

Settings:

Preferences are those facts, either supplied by the user or generated through default settings or analysis that details a site-specific rule to be applied to some aspect of crawling that site. For example, on the Victoria's Secret site, a preference may be that relative image links are reconstructed with the Akamai domain prefix rather than the Victoria's Secret default. This may also include settings reflecting how the user configures the application (e.g. skins, or skill UIs).

Parsing rules are those facts, either supplied by the user or generated through defaults or analysis as to how the targeted site will be parsed. The current implementation is HTML driven however it can be extended to other input types, such as XML, or database driven sites. For example the default implementation parses on a tag-by-tag basis and denotes the beginning of a tag by the ‘<’ symbol and the end of a tag by ‘>’.

Site name the prefix of an absolute link, including the protocol. For example, http://www.victoriassecret.com, http:// a548.g.akamai.net.

Tag—Tags are the delimiters of markup functions in HTML. They are used for a variety of purposes from creating hyperlinked text to demarcating the different sections of an HTML document. HTML Tags are typically identified as text occurring between the characters ‘<’ and ‘>’. Many tags apply their function to all elements between it's open and it's close tag. Examples of tags include: <HTML>, <A href=“notvirtual.com”>, </a>.

Target Site—The root URL of the website which is being converted. The logical website is considered—i.e. it may be remotely or locally stored and need not reside completely within one domain or host.

UI—User Interface.

Wall decal—An object used strictly for the visual improvement of a wall.

Web Store Builder—The second part of the Web Store Converter. The Web Store Builder parses the input files generated by the Web Store Crawler and constructs the output file representing the Web Store in three dimensions. The 3D web store consists a lobby and one room for every department.

Web Store Converter—The application that generates a virtual web store based on information and files from a target site, user preferences and preset VRML components.

Web Store Crawler—The first of two parts, which comprise the Web Store Converter. The Web Store Crawler extracts content (files and information) from a target website URL and generates the necessary input for the Web Store Builder.

We claim:

1. A method of transforming a flat web site comprising a plurality of pages containing items for display, each item being associated with hyperlinks pointing to a target destination, into an immersive web site having a three dimensional virtual environment, comprising:
crawling said flat website and parsing its content;
identifying item links pointing to said items;
for each item locating the associated hyperlink pointing to the target destination;
associating said located item links with their corresponding hyperlinks to form link pairs;
storing said link pairs in memory;
processing said link pairs to remove redundant information and validate the associated data;
grouping said remaining link pairs into subsets;
for each subset creating a virtual room defined as a set of points in a three-dimensional virtual space;
identifying display surfaces in said virtual room; and
arranging said items on said display surfaces within said virtual space to display said items in a realistic setting while preserving said associated hyperlinks to the target destination.

2. A method as claimed in claim 1, wherein said subsets correspond to categories of item.

3. A method as claimed in claim 1, further comprising distributing components in said virtual room, said components constituting basic building blocks geometrically represented in said virtual space.

4. A method as claimed in claim 1, wherein said items are images of articles for display.

5. A method as claimed in claim 1, wherein said items are video or audio files describing items for display.

6. A method as claimed in claim 1, wherein said links are first validated to ensure that they are absolute links and do not fall outside a set of names associated with said target website.

7. A method as claimed in claim 1, wherein said hyperlinks are located by examining mark-up tags in pages of said website.

8. A method as claimed in claim 1, wherein said link pairs are grouped into categories by performing a context analysis based on the originating page of their associated items.

9. A method as claimed in claim 1, wherein said link pairs are grouped into categories by performing a path analysis and organizing said categories according to directories in the path of the objects associated with said link pairs.

10. A method as claimed in claim 9, wherein said link pairs are first duplicated, said item links and hyperlinks are recursively sorted by directories, and the sorted sets are stored in memory for further processing.

11. A method as claimed in claim 1, wherein said link pairs are grouped into subsets by text strings occurring in file names of said objects.

12. A method as claimed in claim 1, wherein said categories represent departments in said virtual environment.

13. A method as claimed in claim 12, further comprising invoking a method with a list of input directories for each department to create a plurality of virtual rooms representing said respective departments.

14. A method as claimed in claim 13, wherein said three-dimensional virtual space is constructed by invoking a room building method which parses input files for a particular room, chooses the room's shape, and creates files to represent said room in a virtual environment.

15. A method as claimed in claim 14, wherein said input files for said rooms contain information selected from the group consisting of: object/URL mappings, room name, and preferred layout scheme.

16. A method as claimed in claim 15, wherein said building blocks have display surfaces with which said objects can be associated.

17. A method as claimed in claim 16, wherein said building blocks are divided into a first group of building blocks that can contain child groups and a second group of building blocks that cannot contain child groups

18. A method as claimed in claim 17, wherein said building blocks are selected from the group consisting of: walls, display cases, tables, pillars, wall decals, doors and picture frames.

19. A method as claimed in claim 15, wherein said building blocks are associated with textures and said room building method matches a room's style with a list of textures associated with said building blocks.

20. A method as claimed in claim 18, wherein said room building method creates walls, and assigns frames and display cases to said walls.

21. A method as claimed in claim 19, wherein said room building method creates a grid representing floor space and installs interior components on said floor space.

22. A method as claimed in claim 20, wherein said room building method further adds tables into said room to support said objects.

23. A method as claimed in claim 1, wherein said web site is a virtual store, and said objects represent merchandise for sale in said store.

24. A method of a transforming an e-commerce flat web site into an immersive three dimensional virtual store, comprising:
crawling said flat website and parsing its content;
refining said data;
grouping said data into departments categorizing merchandise for sale;
retrieving image files representing items for sale to generate input data for a store builder; and
analyzing said data in a store builder, said store builder designing three dimensional virtual rooms defined as a set of points in virtual space and filling said rooms with items representing said items for sale, or display, or representing a service.

25. A web site converter for transforming a flat web site into an immersive web site having a three dimensional virtual environment, comprising:
a web site crawler including a parser for parsing said site and generating input data; and
a web site builder for analyzing said input data, generating three dimensional rooms defined as a set of points in virtual space, and filling said virtual rooms with items identified by said web site crawler.

26. A web site converter as claimed in claim 25, wherein said parser extracts item link pairs comprising the URL of said items and hypertext links pointing to a target destination from said items.

27. A web site converter as claimed in claim 26, wherein said associated items are images of objects for display.

28. A web site converter as claimed in claim 25, wherein said web site builder comprises a premises builder method for designing the layout of virtual premises, and a room builder method for designing individual virtual rooms within said premises and populating said rooms with items derived from said input data.

29. A method of constructing a virtual three dimensional website from a two-dimensional website, comprising:
crawling said existing two-dimensional website and parsing its content to identify hyperlinks;
identifying end links associated with items for display;
associating said end links with hyperlinks pointing to target links to form link pairs;
storing said link pairs in memory;
grouping said link pairs into subsets based on categories associated with virtual store departments; and
creating virtual rooms as a set of points in three dimensional virtual space for said departments with a room builder.

30. A method as claimed in claim 29, wherein basic building blocks are inserted in said virtual space, said basic building blocks being selected from the group consisting of:
walls, display cases, tables, pillars, wall decals, doors and picture frames.

31. A method as claimed in claim 30, wherein a style is associated with each grouping, each room adopts the style associated with the grouping, and when a room component is added, the room builder gives the building block a texture that matches the style for the room in which it is located.

32. A method as claimed in claim 29, further comprising a room writer method that generates output files for use as input into a rendering engine.

33. A method as claimed in claim 32, wherein said output files are in VRML format.
